(19) United States
(12) Patent Application Publication
(10) Pub. No.: US 2006/0208637 A1
(43) Pub. Date: Sep. 21, 2006

(54) Plasma display apparatus

(75) Inventors: Sung-won Seo, Seoul (KR); Seung-won Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/232,880

(22) Filed: Sep. 23, 2005

(30) Foreign Application Priority Data
Mar. 15, 2005 (KR) 2005-0021537

(51) Int. Cl. H01J 17/49

(52) U.S. Cl. 313/582

(57) ABSTRACT

A plasma display apparatus is provided having an improved glass filter. The plasma display includes a panel assembly, and a glass filter provided in front of the panel assembly. The glass filter includes a plurality of a dot parts disposed in front of a glass plate to adjust light transmissivity from the panel assembly and external light reflxibility. Thus, the glass filter may be produced simply, thereby lowering the production cost of the glass filter.

### CROSS-REFERENCE TO RELATED APPLICATIONS

This application claims the benefit under 35 U.S.C. § 119(a) of Korean Patent Application No. 2005-0021537, filed on Mar. 15, 2005, in the Korean Intellectual Property Office, the entire disclosure of which is hereby incorporated by reference.

### BACKGROUND OF THE INVENTION

1. Field of Invention

The present invention relates to a plasma display apparatus. More particularly, the present invention relates to a plasma display apparatus having an improved glass filter disposed in front of a panel assembly.

2. Description of the Related Art

Generally, a plasma display apparatus displays a picture using a plasma display panel (PDP). The plasma display panel is capable of being produced in a large size without difficulty, as well as being relatively thin. Demands for such plasma display panels have been continuously increasing.

A conventional plasma display apparatus includes a panel assembly, a glass filter provided in front of the panel assembly, and a driver provided behind the panel assembly. Particularly, the glass filter, illustrated in FIG. 1, includes a glass 2 plate, a color film 4 provided in front of the glass 2 plate, an anti-reflection (AR) film 6 provided in front of the color film 4, and a mesh film 8 provided behind the glass plate 2.

The color film 4 adjusts light transmissivity from the panel assembly and embodies external colors. The AR film 6 adjusts external light reflexibility.

However, the process for making the glass filter 10 is relatively complex in the plasma display apparatus with the above-described construction. The color film 4 and the AR film 6 are attached in front of the glass panel 2 to adjust light transmissivity from the panel assembly and external light reflexibility.

Additionally, optical film, such as the color film 4 and the AR film 6, has a relatively high production cost, thereby causing high production costs to manufacture the glass filter 10.

Accordingly, a need exists for an improved glass filter for a plasma display apparatus that is simply and inexpensively manufactured.

### SUMMARY OF THE INVENTION

Accordingly, it is an aspect of the present invention to provide a plasma display apparatus capable of functioning efficiently with a glass filter having a simple structure.

Additional aspects and advantages of the invention are set forth in part in the description that follows and, in part, are obvious from the description, or may be learned by practice of the invention.

The foregoing and other aspects of the present invention are achieved by providing a plasma display apparatus including a panel assembly and a glass filter provided in front of the panel assembly. The glass filter includes a glass plate, and a plurality of a dot parts printed in front of the glass plate that adjust light transmissivity from the panel assembly and external light reflexibility.

According to an aspect of the present invention, the plurality of the dot parts may adjust light transmissivity from the panel assembly and external light reflexibility by changing the area of the plurality of dot parts.

According to an aspect of the present invention, a plurality of the dot parts may be disposed regularly or irregularly in front of the glass plate.

According to an aspect of the present invention, an electromagnetic wave cut-off part may be disposed behind the glass plate.

According to an aspect of the present invention, the diameter of the plurality of dot parts may be formed smaller than each red, green, blue cell interval formed in the panel assembly.

According to an aspect of the present invention, the colors of the plurality of dot parts may be black, or other colors except black.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

These and other aspects and advantages of the present invention will become apparent and more readily appreciated from the following description of the embodiments, taken in conjunction with the accompany drawings, in which:

FIG. 1 is an elevational view in cross section of a structure of a glass filter of a conventional plasma display apparatus;

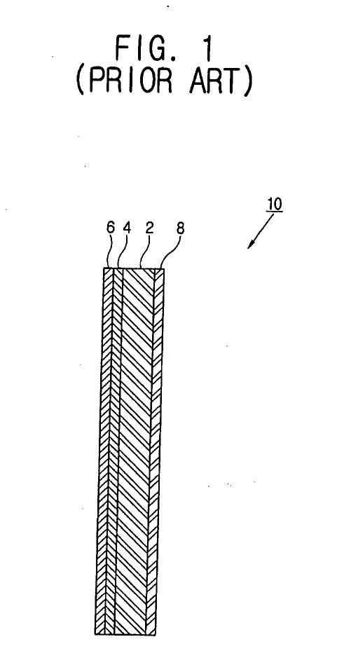

FIG. 2 is an exploded perspective view of a plasma display apparatus according to an exemplary embodiment of the present invention;

FIG. 3 is a front elevational view of a glass panel of a plasma display apparatus according to an exemplary embodiment of the present invention; and

FIG. 4 is a sectional view illustrating a structure of a glass filter of a plasma display apparatus according to an exemplary embodiment of the present invention.

Throughout the drawings, like reference numerals will be understood to refer to like parts, components and structures.

### DETAILED DESCRIPTION OF EXEMPLARY EMBODIMENTS

Reference will now be made in detail to the exemplary embodiments of the present invention, examples of which are illustrated in the accompanying drawings. The exemplary embodiments are described below with reference to the figures.

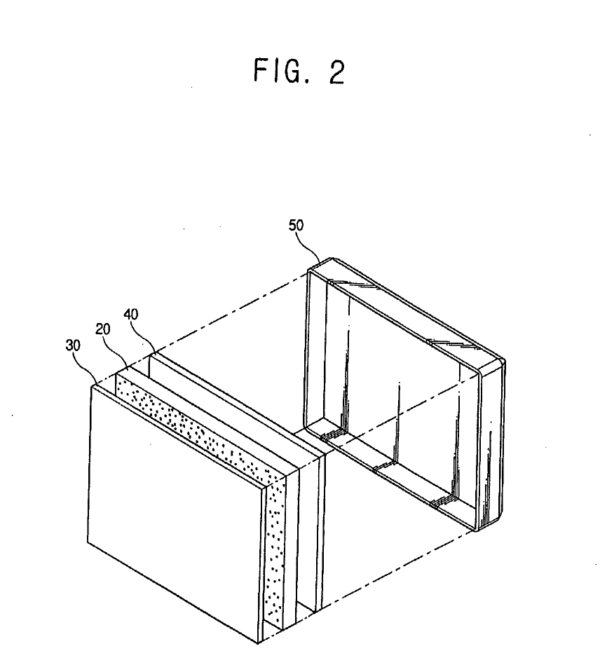

As illustrated in FIGS. 2 through 4, a plasma display apparatus according to an exemplary embodiment of the present invention includes a panel assembly 20, a glass filter 30 disposed in front of the panel assembly 20, a driver 40 disposed behind the panel assembly 20, and a casing 50 disposed rearwardly of the driver 40.

The panel assembly 20 is adapted to form a picture and, although not illustrated, has a front substrate, a rear substrate, and an electrode part between the front substrate and the rear substrate.

The electrode part formed in the panel assembly 20 is driven by the the driver 40.

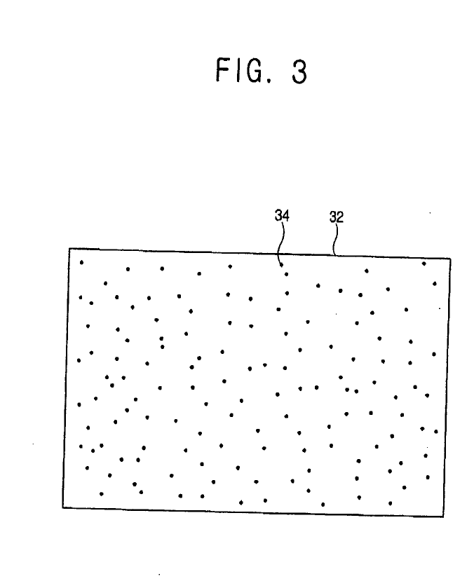

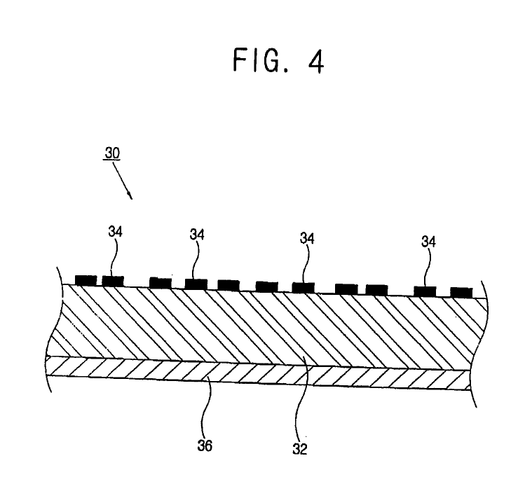

The glass filter 30, as illustrated in FIG. 3 and FIG. 4, includes a glass plate 32, and a plurality of dot parts 34 printed in front of the glass 32, which have a predetermined length and shape.

The glass plate 32 may be selectively applied with material providing durability, heat resistance, and light transmissivity.

The plurality of the dot parts 34 adjusts light transmissivity from the panel assembly 20 and external light reflexibility, thereby functioning as a color film and an anti-reflection film.

Light from the panel assembly 20 passing through the glass plate 32 is partially cut-off by the plurality of the dot parts 34. Thus, the plurality of the dot parts 34 may adjust light transmissivity and decrease external reflexibility.

The size of the plurality of the dot parts 34 may be changed as necessary, therein capable of simply adjusting light transmissivity from the panel assembly 20 and external light reflexibility. Alternatively, the shape and size of each of the plurality of the dot parts 34 may be variously changed.

The size of the dot parts 34 may be formed smaller than each red, green, and blue cell interval formed in the panel assembly 20 to substantially prevent interfering with picture formation. For example, when each red, green, and blue cell interval is 0.3 mm, the size of the dot part 34 is preferably smaller than 0.3 mm.

The plurality of the dot parts 34 may be disposed regularly or irregularly on the glass plate 32. However when the plurality of the dot parts 34 are disposed regularly, a user may see the plurality of the dot parts 34 with naked eyes. Accordingly, it is preferable, but not necessary, that the plurality of the dot parts 34 be disposed irregularly.

The color of the plurality of dot parts 34 is preferably black. Alternatively, an external appearance thereof may be changed by changing the color.

The plurality of dot parts 34 may be simply formed by placing a photo mask with a dot shape on the glass 32 and sputtering ink, or by dipping a roll having dot-shaped projections in ink and rolling the roll on the glass plate 32.

An electromagnetic wave cut-off part 36 is disposed rearwardly of the glass 32 to efficiently cut-off electromagnetic waves from the panel assembly 20. The electromagnetic wave cut-off part 36 may selectively apply a mesh-type or a sputter-type using coating material with conductivity.

As described above, according to an exemplary embodiment of the present invention, the plurality of dot parts 34 are printed on the glass plate instead of an optical film. Therefore the glass filter may be produced simply, thereby lowering the production cost of the glass filter.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display apparatus, comprising:
a panel assembly; and
a glass filter provided in front of the panel assembly,wherein the glass filter includes
a glass plate; and
a plurality of dot parts printed in front of the glass plate that adjust light transmissivity from the panel assembly and external light reflexibility.

2. The plasma display apparatus of claim 1, wherein
the plurality of the dot parts adjust light transmissivity from the panel assembly and external light reflexibility by changing an area of the plurality of the dot parts.

3. The plasma display apparatus of claim 1, wherein
the plurality of the dot parts are disposed irregularly in front of the glass plate.

4. The plasma display apparatus of claim 2, wherein
the plurality of the dot parts are disposed irregularly in front of the glass plate.

5. The plasma display apparatus of claim 1, wherein
an electromagnetic wave cut-off part is disposed behind the glass plate.

6. The plasma display apparatus of claim 1, wherein
the diameter of the plurality of dot parts are formed smaller than each red, green, blue cell interval formed in the panel assembly.

7. The plasma display apparatus of claim 1, wherein
the color of the plurality of dot parts is black.

8. The plasma display apparatus of claim 1, wherein
the colors of the plurality of dot parts are colors other than black.

9. The plasma display apparatus of claim 1, wherein
the plurality of the dot parts are disposed regularly in front of the glass plate.

10. A glass filter for a plasma display apparatus, comprising:
a glass plate having front and rear surfaces disposed in front of a panel assembly of the plasma display apparatus;
a plurality of dot parts disposed on the front surface of the glass plate to adjust light transmissivity from the panel assembly and external light reflexibility; and
an electromagnetic wave cut-off part is disposed behind the glass plate.

11. The glass filter for the plasma display apparatus of claim 10, wherein
the plurality of the dot parts adjust light transmissivity from the panel assembly and external light reflexibility by changing an area of the plurality of the dot parts.

12. The glass filter for the plasma display apparatus of claim 10, wherein
the plurality of the dot parts are irregularly disposed in front of the glass plate.

13. The glass filter for the plasma display apparatus of claim 10, wherein
the diameter of the plurality of dot parts are smaller than each red, green, blue cell interval formed in the panel assembly.

14. The glass filter for the plasma display apparatus of claim 10, wherein
the color of the plurality of dot parts is black.

15. The glass filter for the plasma display apparatus of claim 10, wherein
the colors of the plurality of dot parts are colors other than black.

16. The glass filter for the plasma display apparatus of claim 10, wherein
the plurality of the dot parts are regularly disposed in front of the glass plate.

17. A method of forming a glass filter for a plasma display apparatus, comprising:
disposing a glass plate having front and rear surfaces in front of a panel assembly of the plasma display apparatus;
disposing a plurality of dot parts on the front surface of the glass plate to adjust light transmissivity from the panel assembly and external light reflexibility; and
disposing an electromagnetic wave cut-off part behind the glass plate.

18. A method of forming a glass filter for a plasma display apparatus according to claim 17, further comprising
disposing the plurality of dot parts on the front surface of the glass plate by disposing a photo mask with a dot shape on the glass plate and sputtering ink on the photo mask to dispose the plurality of dot parts on the glass plate.

19. A method of forming a glass filter for a plasma display apparatus according to claim 17, further comprising
disposing the plurality of dot parts on the front surface of the glass plate by dipping a roller having projections in ink and rolling the dipped roller on the front surface of the glass plate.

20. A method of forming a glass filter for a plasma display apparatus according to claim 17, further comprising
disposing the plurality of dot parts irregularly on the front surface of the glass plate.
